(19) United States
(12) Patent Application Publication
(10) Pub. No.: US 2013/0193920 A1
(43) Pub. Date: Aug. 1, 2013

(54) APPARATUS AND METHOD OF DUAL USE RESISTOR FOR BATTERY DISCONNECT

(71) Applicant: Lear Corporation, Southfield, MI (US)

(72) Inventors: Greg Dickerhoof, Ann Arbor, MI (US); Aric Anglin, Rives Junction, MI (US)

(73) Assignee: LEAR CORPORATION, Southfield, MI (US)

(21) Appl. No.: 13/741,945

(22) Filed: Jan. 15, 2013

Related U.S. Application Data
(60) Provisional application No. 61/590,892, filed on Jan. 26, 2012.

(51) Int. Cl. H02J 7/02

(52) U.S. Cl. CPC H02J 7/02
USPC 320/109

(57) ABSTRACT

A vehicle apparatus comprising a battery charger is provided. The battery charger is operably coupled to a power grid to receive AC energy during a vehicle charging operation and is operably coupled to a switching circuit for one of connecting and disconnecting the battery in the vehicle. The switching circuit includes a single resistor and is arranged to enable a pre-charge operation and a battery heating operation. The battery charger is configured to convert the AC energy into DC energy for delivering at least a portion of the DC energy to the single resistor for performing the battery heating operation when the vehicle charging operation is being performed.

### CROSS-REFERENCE TO RELATED APPLICATIONS

This application claims the benefit of U.S. provisional Application No. 61/590,892 filed on Jan. 26, 2012, the disclosure of which is incorporated in its entirety by reference herein.

### TECHNICAL FIELD

Embodiments disclosed herein generally relate to an apparatus and method of dual use resistor for a battery disconnect.

### BACKGROUND

It is known to provide a resistor that is used in connection with a pre-charging function and battery heating. One example of this is set forth in U.S. Publication No. 2012/0040224 (the “'224 Publication”) to Reischmann et al.

The '224 Publication provides a battery circuit for an electric vehicle that employs a resistor that performs both a pre-charging function at system start-up and battery heating. The battery circuit includes a positive high voltage bus line electrically coupled to a positive terminal of the battery and a negative high voltage bus line electrically coupled to the negative terminal of the battery. A first end of the resistor is electrically coupled to the positive high voltage bus line, a first switch is electrically coupled between a second end of the resistor and the positive high voltage bus line and a second switch is electrically coupled between the second end of the resistor and the negative high voltage bus line. The pre-charging operation is provided when the first switch is closed and the second switch is opened. The heating function is provided when the second switch is closed and the first switch is opened.

### SUMMARY

A vehicle apparatus comprising a battery charger is provided. The battery charger is operably coupled to a power grid to receive AC energy during a vehicle charging operation and is operably coupled to a switching circuit for one of connecting and disconnecting the battery in the vehicle. The switching circuit includes a single resistor and is arranged to enable a pre-charge operation and a battery heating operation. The battery charger is configured to convert the AC energy into DC energy for delivering at least a portion of the DC energy to the single resistor for performing the battery heating operation when the vehicle charging operation is being performed.

### BRIEF DESCRIPTION OF THE DRAWINGS

The embodiments of the present disclosure are pointed out with particularity in the appended claims. However, other features of the various embodiments will become more apparent and will be best understood by referring to the following detailed description in conjunction with the accompany drawings in which:

FIG. 1 depicts a vehicle apparatus for operably connecting and disconnecting a battery in a first mode in accordance to one embodiment;

FIG. 2 depicts the vehicle apparatus of FIG. 1 in a second mode in accordance to one embodiment;

FIG. 3 depicts the vehicle apparatus of FIG. 1 in a third mode in accordance to one embodiment;

FIG. 4 depicts a vehicle apparatus for operably connecting and disconnecting a battery in a first mode in accordance to one embodiment;

FIG. 5 depicts the vehicle apparatus of FIG. 4 in a second mode in accordance to one embodiment; and

FIG. 6 depicts the vehicle apparatus of FIG. 4 in a third mode in accordance to one embodiment.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

The embodiments of the present disclosure generally provide for a plurality of circuits or other electrical devices. All references to the circuits and other electrical devices and the functionality provided by each, are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microprocessors, integrated circuits, memory devices (e.g., FLASH, random access memory (RAM), read-only memory (ROM), electrically programmed read-only memory or (EPROM), electrically erasable programmable read-only-memory (EEPROM), or other suitable variants thereof) and software which co-act with one another to perform operation(s) as disclosed herein.

A battery system in, but not limited to, a hybrid or electric plug-in vehicle may utilize, for example, a pre-charge function for a smooth transition to match voltages before activating main contactors. A liquid-cooled battery, for example, may utilize a heating function to achieve operating temperatures in cold weather.

In one implementation as disclosed herein, a battery system may combine pre-charge and heating function via a single resistor (e.g., tapped thick film resistor) that may be adhered to an outer surface of a tube carrying flowing coolant. The single tap resistor may allow for independent resistance values for each function (e.g., pre-charge and heating) to minimize cost.

In one implementation as disclosed herein, a battery system may combine pre-charge and heating functions by using a single untapped resistor that may be adhered to the outer surface of the tube carrying flowing coolant (or some other resistive heating element). The untapped configuration may include that the heating function is not activated during pre-charge. Also, the untapped configuration may provide a single resistance value that is compatible with both the heater function and the pre-charge function. It is recognized that the implementations disclosed herein may provide a single resistor that may reduce cost and/or packaging space. These aspects and more will be described in more detail below.

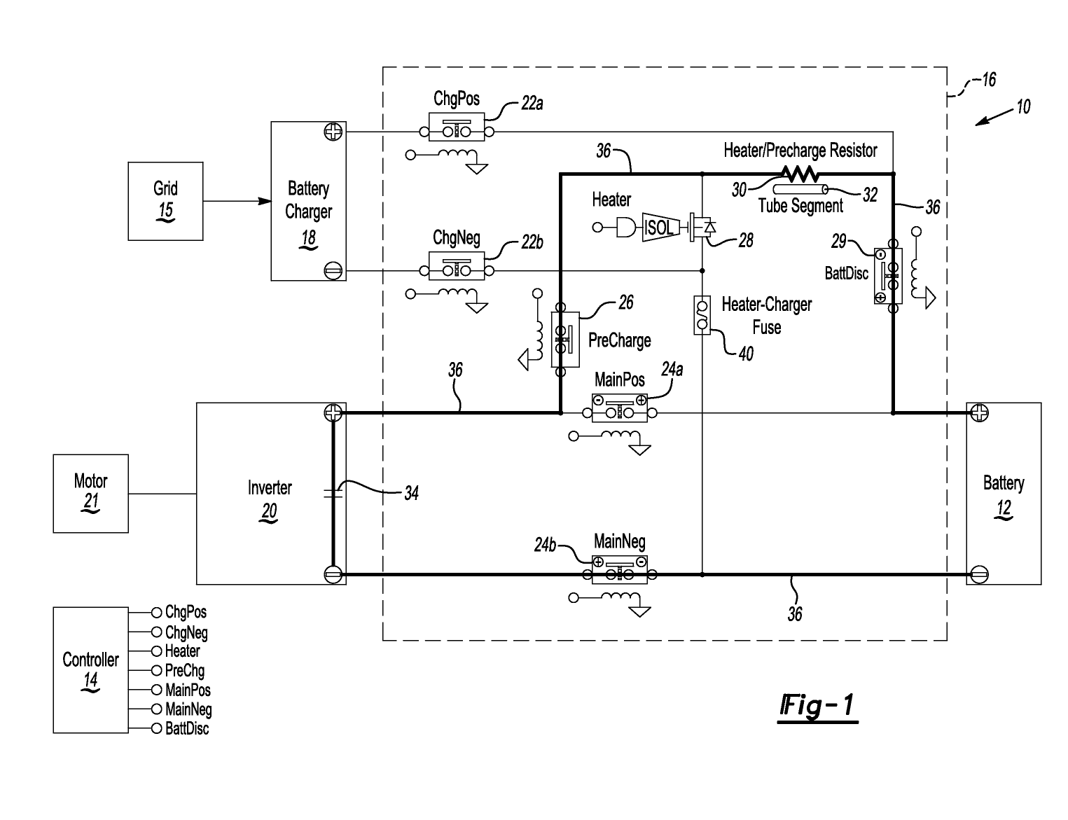

FIG. 1 depicts a vehicle apparatus 10 for operably connecting and disconnecting a battery 12 in a first mode. The apparatus 10 generally includes a controller 14 and a switching circuit 16. In general, the controller 14 may control various switches within the switching circuit 16 to perform a pre-charge function and a heating function. The switches within the switching circuit 16 will be described in more detail below. A battery charger 18 is operably coupled to the battery 12. The battery charger 18 converts an AC voltage as received from grid 15 into a high DC voltage for storing such DC voltage on the battery 12 (e.g., vehicle undergoes a charging operation). A portion of the DC voltage may be used for the pre-charge or battery heater function. The battery charger 18 provides the high DC voltage to the battery 12 via the switching circuit 16. An inverter 20 is operably coupled to the battery 12 via the switching circuit 16. The inverter 20 is configured to convert the high DC voltage from the battery 12 into an AC voltage to drive a motor 21 in a vehicle.

In general, the switching circuit 16 generally includes a plurality of switching devices, which may in the form of, but not limited to, contactors, relays, field effect transistors (FETs) etc. In general, the switching circuit 16 generally includes contactor 22a, contactor 22b, contactor 24a, contactor 24b (e.g., contactors 24a and 24b may be main contactors), contactor 26 (or pre-charge contactor 26), FET 28, and a battery disconnect contactor 29. While FIG. 1 may illustrate that a number of the switching devices are arranged as contactors and a transistor, it is recognized that such switching devices may be a switch, relay, transistor, etc. The switching circuit 16 further includes a single heater/pre-charge resistor 30 and a tube segment 32 positioned about the resistor 30. The resistor 30 is generally arranged to provide a common resistance value to enable both a pre-charging function and a heating function which will be described in more detail below. Such a configuration may minimize cost in addition to package space.

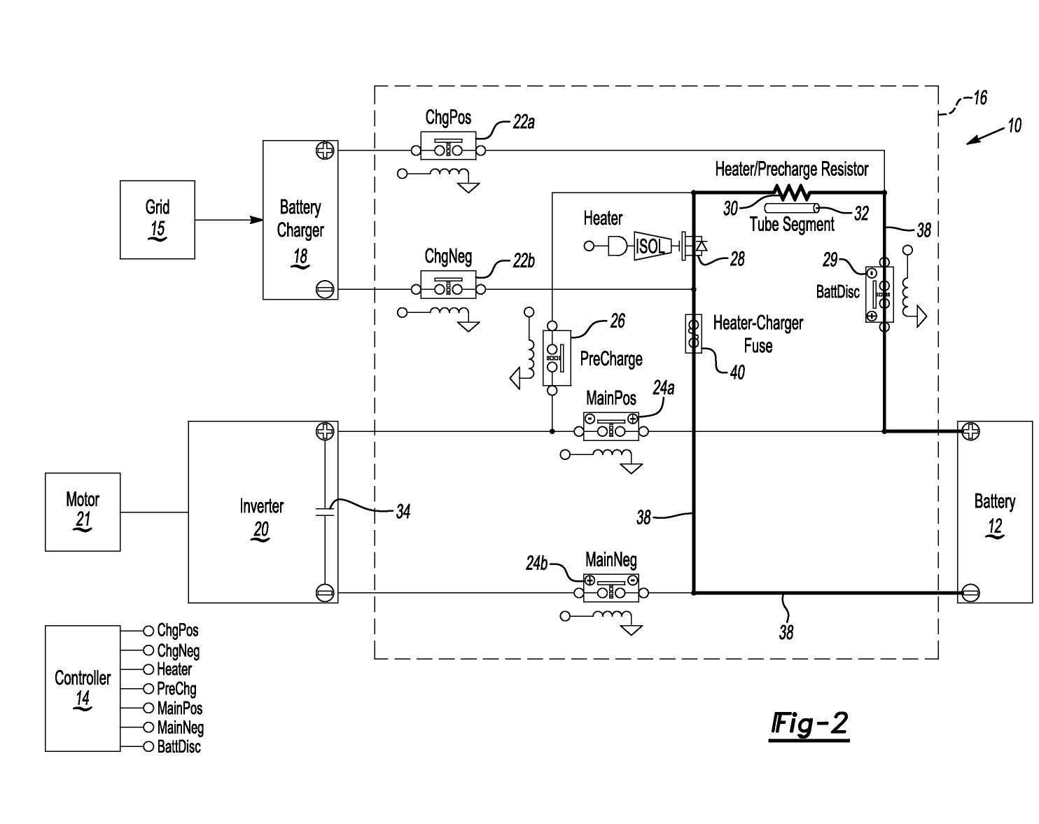

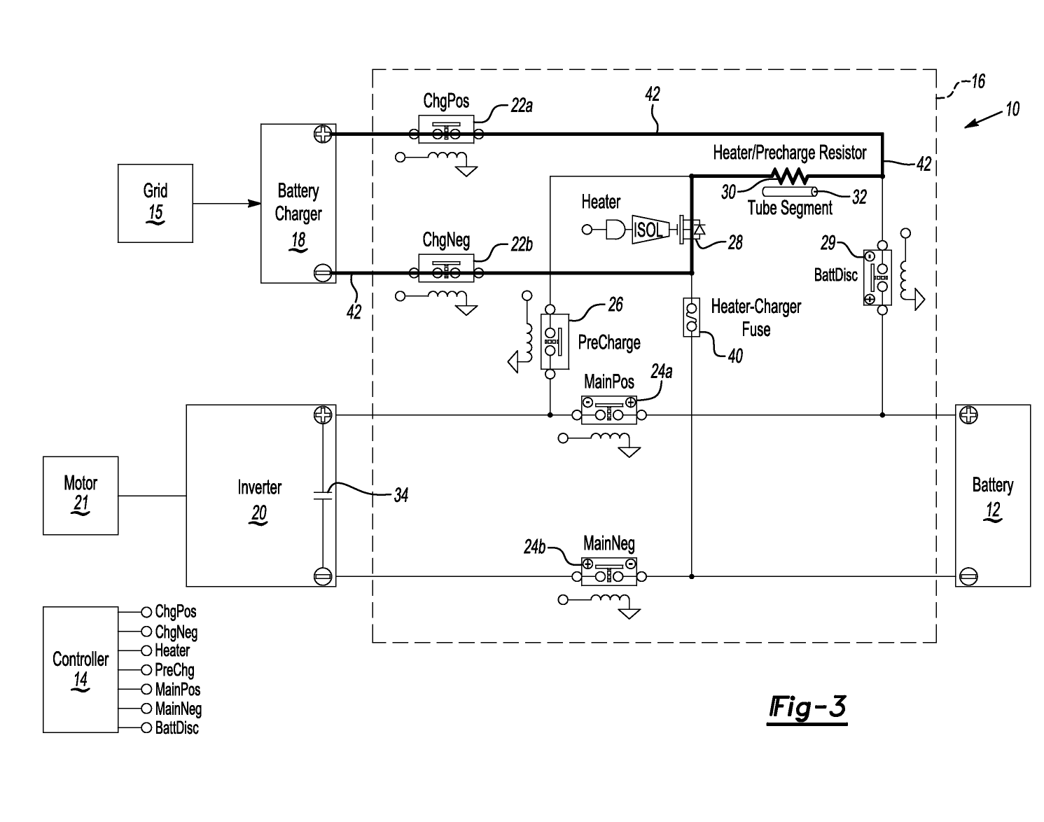

The resistor 30, upon drawing current, is generally arranged to heat liquid flowing through the tube segment 32 to heat the battery 12. The tube segment 32 is generally arranged to extend about the battery 12, and the resistor 30 for thermally communicating with the same. This will be discussed in more detail in connection with FIGS. 2-3.

FIG. 1 generally illustrates the apparatus 10 operating in a first mode (e.g., pre-charging mode). In general, the battery 12 is selectively coupled to the inverter 20 via the main contactors 24a and 24b. Upon starting the vehicle, the controller 14 is generally configured to activate the contactor 24a via signal MAINPOS and to active the contactor 24b via signal MAINNEG. This condition allows the high voltage as stored on the battery 12 to be delivered to the inverter 20 for purposes of driving the motor 21. Prior to activating the contactor 24a and 24b, it may be desirable to pre-charge capacitor 34 positioned about the inverter 20. For example, the capacitor 34, after the contactors 24a and 24b have been closed, may receive a high DC voltage input from the battery 12 and may experience a short circuit condition for a very small amount of time before the capacitor 34 is fully charged. Such a brief short circuit condition may degrade various electronics within the apparatus 10.

To account for the degrading effect on the electronics, the controller 14 may activate the pre-charge contactor 26 via signal PRECHG and the contactor 24b via signal MAINNEG prior to activating the main contactor 24a during a vehicle start up condition. FIG. 1 generally illustrates path 36 in which power flows from the battery 12 to the inverter 20. The resistor 30, once the pre-charge contactor 26 and the contactor 24b is active, functions to limit current from the battery 12 to the inverter 20 thereby causing the capacitor 34 to pre-charge before the controller 14 activates the main contactor 24a. Such a condition may eliminate the brief short circuit condition (or large spikes) at the capacitor 34. Once the capacitor 34 is charged, the controller 14 then deactivates the pre-charge contactor 26 and activates the contactor 24a while continuing to keep the contactor 24b active. It is recognized that the controller 14 may activate the contactor 24a just before deactivating the pre-charge contactor 26 to avoid an intervening drop in voltage during the transition. This condition will allow the battery 12 to provide the high DC voltage to the inverter 20.

FIG. 2 generally illustrates the apparatus 10 operating in a second mode (or a first heating mode) in which the battery 12 is heated. In the second mode, the vehicle may be parked and temperature may be below a predetermined threshold and it may be desirable to heat the battery 12. For example, it may be desirable to raise the temperature of the battery 12 to a predetermined temperature range for performance purposes in moments of cold operating temperature. In the second mode, the charger 18 may communicate with the controller 14 that the vehicle is in the parked state, that the temperature is below the predetermined threshold, and that the vehicle is not being charged. Either the controller 14 or the battery charger 18 may be operably coupled to a temperature sensor (not shown) to obtain an exterior temperature reading. The fact that the vehicle is not being charged serves to indicate that the battery 12 provides power to perform the heating operation. The battery disconnect contactor 29 is closed via signal BattDisc to enable the battery 12 to provide power. In the event the vehicle is being charged, then power from grid 15 will be used to perform the heating operation. This will be described in more detail in connection FIG. 3.

Accordingly, the controller 14 may activate FET 28 via signal HEATER. Path 38 illustrates that power flows from positive side of battery 12, the resistor 30, the FET 28, the battery disconnect contactor 29, a fuse 40 and back to negative side of battery 12. In general, while the resistor 30 receives power, the resistor 30 heats liquid that flows through the tube segment 32. The battery 12 is thermally coupled to the tube segment 32 for receiving the heated coolant. The resistance value of the resistor 30 may be the same for purposes of performing the heating operations (also for that noted in connection with FIG. 3) as well as for the pre-charge operation. This condition may minimize cost in addition to packaging space.

FIG. 3 generally illustrates the apparatus 10 of FIG. 1 operating in a third mode (or a second heating mode) in which the battery 12 is heated. However, in the third mode, at least a portion of the energy provided from the grid 15 will power the heating function as opposed to power provided from the battery 12. This condition may be more economical. Accordingly, in the third mode, the controller 14 determines whether the vehicle is being charged or not in addition to whether the temperature is below the predetermined threshold. In the event the controller 14 determines that the vehicle is being charged and that the temperature is below the predetermined threshold, the controller 14 activates the contactors 22a and 22b via signals CHGPOS and CHGNEG, respectively and further activates FET 28 via the signal HEATER to initiate the heating operation. The controller 14 also deactivates the battery disconnect contactor 29 to prevent any power draw from the battery 12 to preserve charge. Power from the grid 15 (e.g., power as conditioned and provided from the battery charger 18) is used to power the FET 28, which in turn powers the heating operation of the battery 12. Path 42 illustrates that power flows from positive side of charger 18 (i.e., from the grid 15), contactor 22a, the contactor 29, resistor 30, contactor 22b, and back to negative side of charger 18.

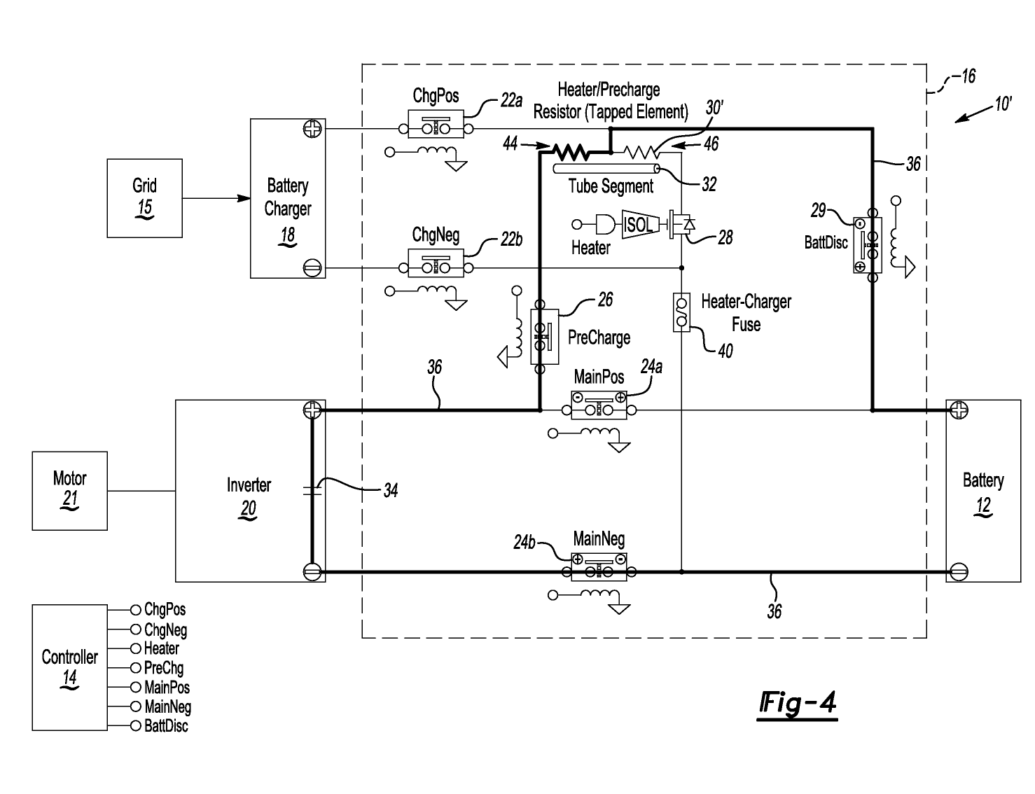

FIG. 4 depicts a vehicle apparatus 10′ for operably connecting and disconnecting the battery 12 in the first mode. The apparatus 10′ is generally similar to the apparatus 10 with the exception of resistor 30′. For example, the resistor 30′ as provided in the apparatus 10′ is formed of a single tapped resistor (e.g., thick film resistor). The resistor 30′ includes a first portion 44 and a second portion 46. The resistance value for the first portion 44 may be different than that of the second portion 46. This condition may enable, for example, the use of the first portion 44 to be used in connection with the first mode (e.g., the pre-charging operation) while the second portion 46 may be used with the second mode (e.g., the heating operations) (or vice versa).

As noted above, the first mode generally corresponds to a pre-charging operation that is being performed. Accordingly, in the first mode, the controller 14 activates the pre-charge contactor 26 via signal PRECHG and the contactor 24b via signal MAINNEG prior to activating the main contactor 24a during a vehicle start up condition. In response to the pre-charge contactor 26 and the contactor 24b being activated, path 36 illustrates that power flows from the battery 12, the first portion 44 of the resistor 30′, the pre-charge contactor 26, positive side of inverter 20, the capacitor 34, negative side of the inverter 20, the contactor 24b, and back to negative side of battery 12.

The first portion 44 of the resistor 30′, once the pre-charge contactor 26 and the contactor 24b is active, functions to limit current from the battery 12 to the inverter 20 thereby causing the capacitor 34 to charge before the controller 14 activates the main contactor 24a. Such a condition may eliminate the short circuit condition (or large spikes) at the capacitor 34 in the event the main contactors 24a and 24b are activated without first pre-charging the capacitor 34. Once the capacitor 34 is charged, the controller 14 activates the contactor 24a just prior to deactivating the pre-charge contactor 26 while continuing to activate the contactor 24b. This condition will allow the battery 12 to provide the high DC voltage to the inverter 20.

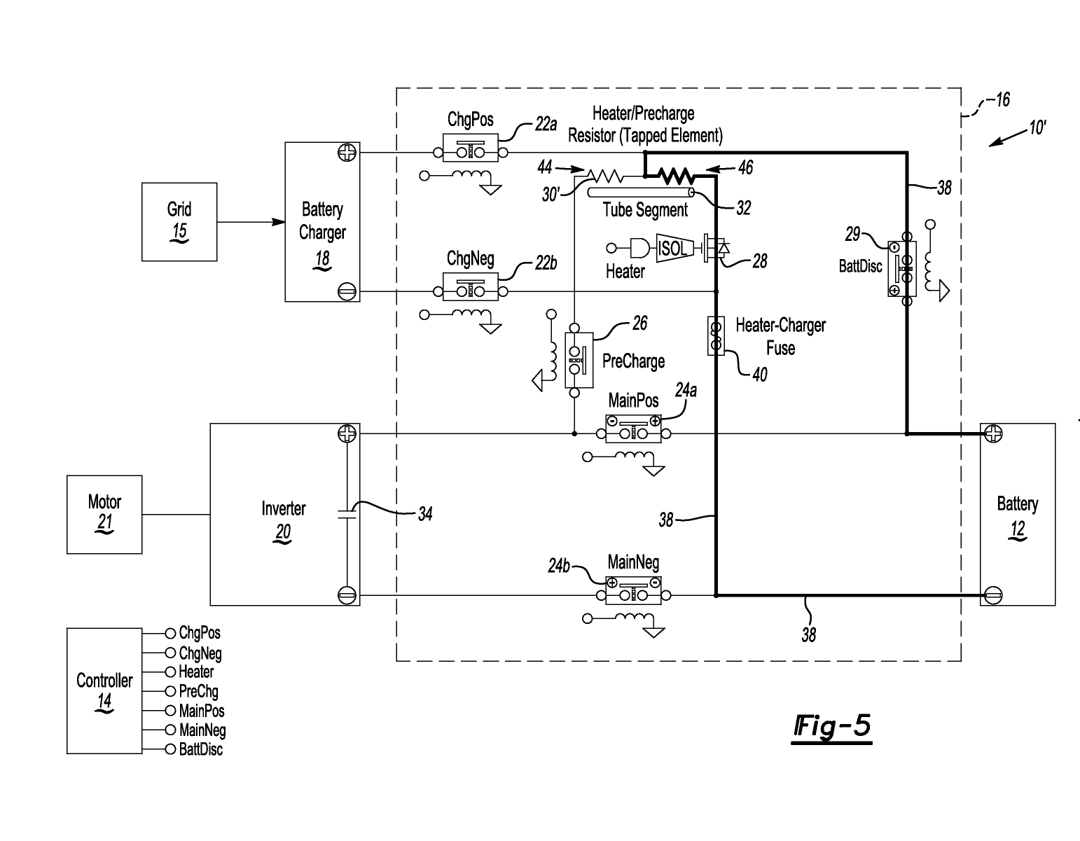

FIG. 5 depicts the vehicle apparatus 10′ of FIG. 4 in the second mode (or the first heating mode) in accordance to one embodiment. As noted above, in the second mode, the vehicle 12 may be parked and temperature may be below the predetermined threshold and it may be desirable to heat the battery 12. For example, it may be desirable to raise the temperature of the battery 12 to a predetermined temperature range for performance purposes in moments of cold operating temperature. In the second mode, the charger 18 may communicate with the controller 14 that the vehicle is in the parked state, that the temperature is below the predetermined threshold, and that the vehicle is not being charged. Accordingly, the controller 14 may activate FET 28 via signal HEATER. Path 38 illustrates that power flows from positive side of battery 12, the battery disconnect contactor 29, the second portion 46 of the resistor 30, the FET 28, the fuse 40 and back to negative side of battery 12.

As further noted above, the resistance value of the second portion 46 of the resistor 30′ may be different than the resistance value of the first portion 44. For example, the resistance value of the second portion 46 may be suitable for heating operations while the resistance value of the first portion 44 may be suitable for the pre-charge operation. By providing a single tapped resistor 30′, this condition may minimize cost and packaging space when compared to an implementation that used multiple resistors with each having different resistance values to enable the pre-charge and heating operations.

In this second mode, the second portion 46 the resistor 30′ receives power from the battery 12, which in turn heats liquid that flows through the tube segment 32. The battery 12 is thermally coupled to the tube segment 32 for receiving the heated coolant.

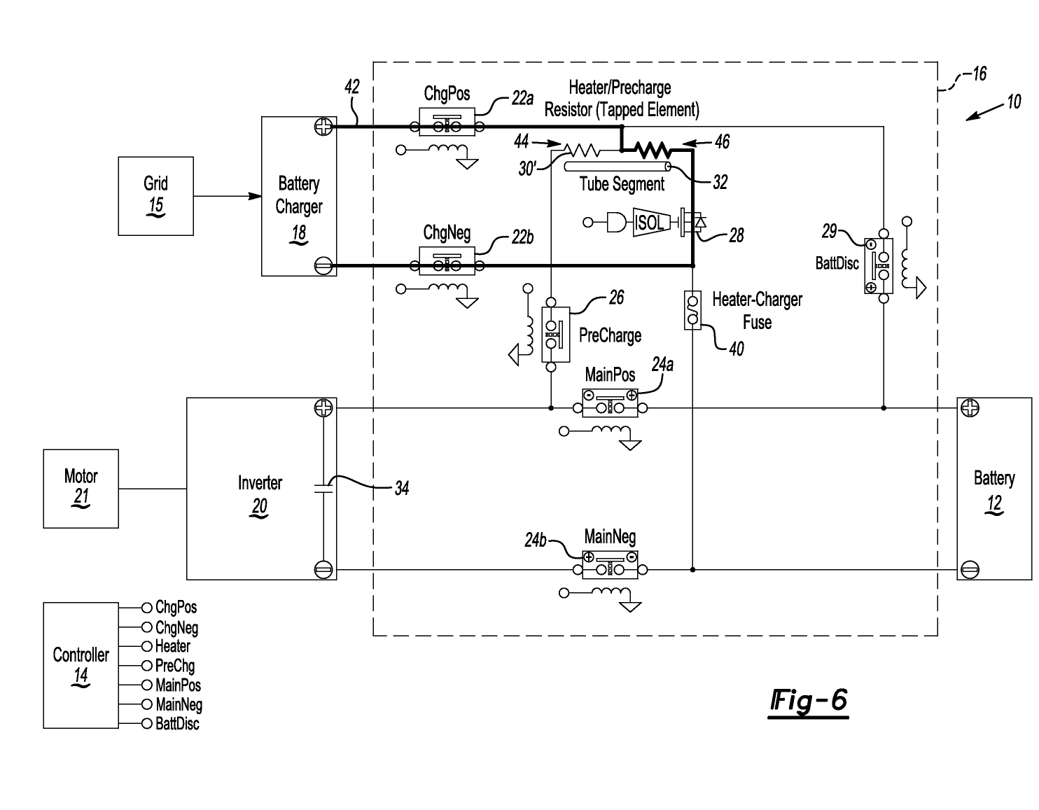

FIG. 6 depicts the vehicle apparatus 10′ of FIG. 4 operating in the third mode (or the second heating mode) in which the battery 12 is heated via energy as provided by the grid 15 through the battery charger 18. As noted above, in the third mode, the controller 14 determines whether the vehicle is being charged or not in addition to whether the temperature is below the predetermined threshold. In the event the controller 14 determines that the vehicle is being charged and that the temperature is below the predetermined threshold, the controller 14 activates the contactors 22a and 22b via signals CHGPOS and CHGNEG, respectively and further activates FET 28 via the signal HEATER to initiate the heating operation. The controller 14 also deactivates the battery disconnect contactor 29 to prevent any power from being drawn from the battery 12 to preserve charge. Power from the grid 15 (e.g., power as conditioned and provided from the battery charger 18) is used to power the FET 28, which in turn powers the heating operation of the battery 12.

Path 42 illustrates that power flows from the grid 15, positive side of charger 18, the contactor 22a, the second portion 44 of the resistor 30′, the contactor 22b, and back to negative side of charger 18. In this third mode, the second portion 46 the resistor 30′ receives power, which in turn heats liquid that flows through the tube segment 32 for heating the battery 12.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A vehicle apparatus comprising:
a battery charger for being operably coupled to a power grid to receive AC energy during a vehicle charging operation and for being operably coupled to a switching circuit for one of connecting and disconnecting the battery in the vehicle, the switching circuit including a single resistor and being arranged to enable a pre-charge operation and a battery heating operation, the battery charger being configured to:
convert the AC energy into DC energy for delivering at least a portion of the DC energy to the single resistor for performing the battery heating operation when the vehicle charging operation is being performed.

2. The apparatus of claim 1 wherein the battery charger is further configured to deliver the at least a portion of the DC energy to the single resistor for performing the battery heating operation in response to a temperature being below a predetermined threshold.

3. The apparatus of claim 1 wherein the battery charger is further configured to deliver the at least a portion of the DC energy to the single resistor in response to the switching circuit disconnecting the battery in the vehicle.

4. The apparatus of claim 1 wherein the single resistor comprises a single tapped resistor including a first portion and a second portion.

5. The apparatus of claim 4 wherein the first portion comprises a first resistance value and the second portion comprises a second resistance value, the first resistance value being different than the second resistance value.

6. The apparatus of claim 1 wherein the single resistor includes a common resistance value that used in connection with the pre-charge operation and the battery heating operation.

7. The apparatus of claim 1 wherein the single resistor is positioned about a tube segment for heating a coolant in response to the single resistor receiving the at least the portion of the DC energy.

8. A vehicle apparatus comprising:
a switching circuit for one of connecting and disconnecting a battery in a vehicle, the switching circuit including a single resistor and being arranged to enable a pre-charge operation and a battery heating operation; and
a battery charger for being operably coupled to a power grid to receive AC energy during a vehicle charging operation and for being operably coupled to the switching circuit for one of connecting and disconnecting the battery in the vehicle, the battery charger being configured to convert the AC energy into DC energy for delivering at least a portion of the DC energy to the single resistor for performing the battery heating operation when the vehicle charging operation is being performed.

9. The apparatus of claim 8 wherein the battery charger is further configured to deliver the at least a portion of the DC energy to the single resistor for performing the battery heating operation in response to a temperature being below a predetermined threshold.

10. The apparatus of claim 8 wherein the battery charger is further configured to deliver the at least a portion of the DC energy to the single resistor in response to the switching circuit disconnecting the battery in the vehicle.

11. The apparatus of claim 8 wherein the single resistor comprises a single tapped resistor including a first portion and a second portion.

12. The apparatus of claim 11 wherein the first portion comprises a first resistance value and the second portion comprises a second resistance value, the first resistance value being different than the second resistance value.

13. The apparatus of claim 8 wherein the single resistor includes a common resistance value that used in connection with the pre-charge operation and the battery heating operation.

14. The apparatus of claim 8 wherein the single resistor is positioned about a tube segment for heating a coolant in response to the single resistor receiving the at least the portion of the DC energy.

15. A vehicle apparatus comprising:
a switching circuit for one of connecting and disconnecting a battery in a vehicle, the switching circuit including a single resistor and being arranged to enable a pre-charge operation and a battery heating operation, the switching circuit for being operably coupled to a battery charger that is operably coupled to a power grid that receives AC energy during a vehicle charging operation and that converts the AC energy into DC energy for delivering at least a portion of the DC energy to the single resistor for performing the battery heating operation when the vehicle charging operation is being performed.

16. The apparatus of claim 15 wherein the battery charger is further configured to deliver the at least a portion of the DC energy to the single resistor for performing the battery heating operation in response to a temperature being below a predetermined threshold.

17. The apparatus of claim 15 wherein the battery charger is further configured to deliver the at least a portion of the DC energy to the single resistor in response to the switching circuit disconnecting the battery in the vehicle.

18. The apparatus of claim 15 wherein the single resistor comprises a single tapped resistor including a first portion and a second portion.

19. The apparatus of claim 18 wherein the first portion comprises a first resistance value and the second portion comprises a second resistance value, the first resistance value being different than the second resistance value.

20. The apparatus of claim 15 wherein the single resistor includes a common resistance value that used in connection with the pre-charge operation and the battery heating operation.
